(19) United States
(12) Patent Application Publication
(10) Pub. No.: US 2011/0196928 A1
(43) Pub. Date: Aug. 11, 2011

(54) SYSTEM AND METHOD FOR PROVIDING DYNAMIC AND INTERACTIVE WEB CONTENT AND MANAGING ATTENDEES DURING WEBCASTING EVENTS

(75) Inventor: Jeff Pryhuber, Lake Zurich, IL (US)

(73) Assignee: INXPO, INC., Chicago, IL (US)

(21) Appl. No.: 13/024,284

(22) Filed: Feb. 9, 2011

Related U.S. Application Data
(60) Provisional application No. 61/302,644, filed on Feb. 9, 2010.

(51) Int. Cl. G06F 15/16

(52) U.S. Cl. 709/204

(57) ABSTRACT

A webcasting system that provides a webcast presenter and webcast attendees with multiple interactive means of connecting and communicating is disclosed. A webcast presenter may create and send webcast slides, which include references to dynamic and interactive content, to webcast attendees. Attendees may view the webcast slides and interact with the dynamic and interactive content provided through the references. Webcast presenters may control an attendee's ability to interact with the interactive content. Additionally, webcast presenters may allow attendees to break away from a main webcast presentation into smaller presentation or group.

### RELATED APPLICATIONS

The present non-provisional utility application claims priority under 35 U.S.C. 119(e) to co-pending provisional application No. 61/302,644 titled “System and Method for Providing Dynamic/Interactive Web Content & Managing Attendees During Webcasting Events,” filed on Feb. 9, 2010, and which is hereby incorporated by reference herein.

### FIELD OF THE INVENTION

Aspects of the present invention relate to webcasting, and in particular, to a system and method for providing interactive webcasting.

### BACKGROUND

Webcasting has become a mainstream method for delivering information to a large audience over the Internet. Through the creation of a webcast presentation, a presenter can present topic driven media and related information over a communication network to a large number of viewers, both in real-time or on-demand. For example, a University may offer on-line courses in which the instructor webcasts a pre-recorded or live lecture, a business enterprise may webcast a press conference in lieu of or in addition to a conference call, or a commercial organization may webcast a product sales promotional presentation.

Although numerous webcasting products and systems exist in the marketplace, several aspects of existing webcast products limit their potential use. First, present webcasting products only offer the ability to display static content to viewers. For example, many existing webcast products are developed in flash, which limits what can be rendered by the webcast system to only a video or an image, neither of which viewers may interact with. Accordingly, existing webcasting systems provide a monotonous experience to viewers, as they are functionally incapable of allowing viewers to dynamically interact with the content being presented through the webcast. Another aspect that has limited the potential use of existing webcasting products is the inability for webcast presenters to manage viewers. Existing webcasting products limit an individual viewer's experience to a standard presentation that every webcast viewer must experience at the same time. For example, webcast presenters cannot break viewers into smaller groups during a webcast. Accordingly, it is desirable to create webcasting methods and systems with these issues in mind.

### SUMMARY

According to one aspect, a method is provided for providing an interactive webcast. The method includes receiving, at one or more processors, one or more references, the one or more references providing access to interactive web content. The method also includes generating for display to an attendee, one or more webcast slides based on the one or more references, the one or more webcast slides enabling the attendee to interact with the interactive web content, at the processor. The method includes managing, at the one or more processors, the webcast slide displayed to the attendee.

According to another aspect, an interactive webcast application includes modules that are executable by a processor to generate an interactive webcast. The interactive webcast application includes a reference module to receive one or more references, the references providing access to interactive web content. The interactive webcast application includes a slide view creation module to generate for display to an attendee, one or more slide views based on the references, the one or more slide views enabling the attendee to interact with the interactive web content. The interactive webcast application includes a management module to manage the one or more webcast slides being displayed to the attendee.

According to yet another aspect, a system for generating an interactive webcast is provided. The system includes one or more processors. The system is capable of executing an interactive webcast application comprising modules executable by the one or more processors. The interactive webcast application includes a reference module to receive one or more references, the references providing access to interactive web content. The interactive webcast application includes a slide view creation module to generate for display to an attendee, one or more slide views based on the references, the one or more slide views enabling the attendee to interact with the interactive web content. The interactive webcast application includes a management module to manage the one or more webcast slides being displayed to the attendee.

### BRIEF DESCRIPTION OF THE DRAWINGS

FIG. 1 is a block diagram of an example computing system, for providing interactive content during a webcast.

FIG. 2 is a block diagram of an interactive webcast application according to one aspect of an interactive webcast system.

FIG. 3 is a flowchart illustrating a method form for providing interactive content during a webcast.

FIG. 4 is another flowchart illustrating a method form for providing interactive content during a webcast.

FIG. 5 is a block diagram illustrating a webcast slide.

### DETAILED DESCRIPTION

Aspects of the interactive webcast system include methods and systems for providing interactive web content to attendees during a webcast presentation. Other aspects of the interactive webcast system enable presenters to generate webcast slides for webcast presentation that allow attendees to access external interactive web content. Aspects of the interactive webcast system may also enable presenters to direct and manage the interactive content attendees are able to view and access during a webcast presentation. For example, presenters may direct attendees in and out of the main webcast presentations and sub-presentations known as breakout sessions.

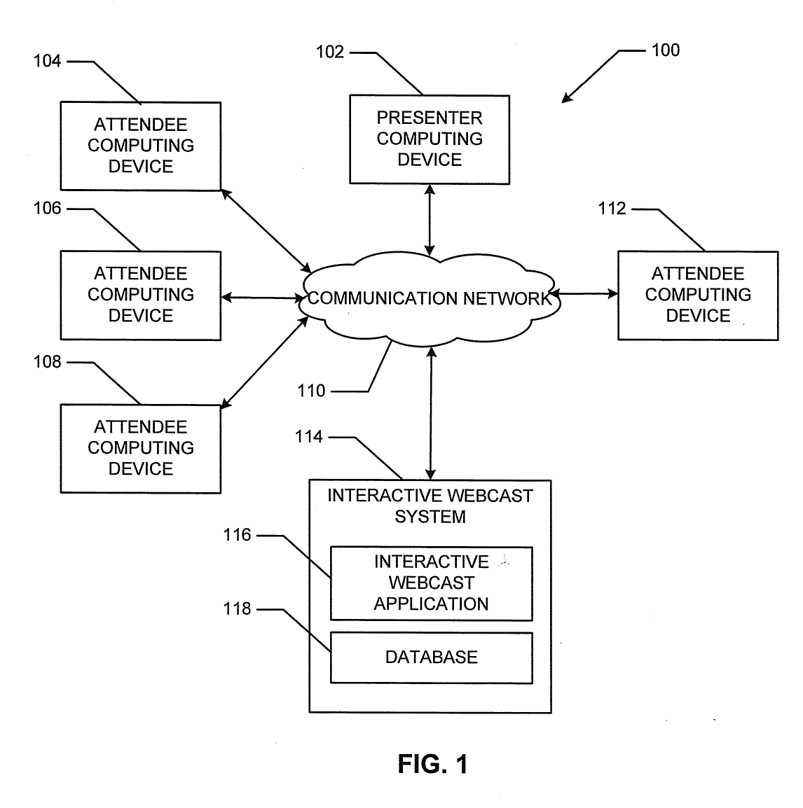

FIG. 1 is system diagram of one possible implementation of a computing environment 100 for providing interactive content during a webcast. The computing environment 100 includes a presenter computing device 102, attendee computing devices 104, 106, 108, and 112, and an interactive webcast system 114 (“IWS”).

According to one aspect, each computing device is a computer or a processing device, such as a personal computer, a server computer, or a mobile processing device. Each computing device includes one or more processors that process software or other machine-readable instructions and includes a memory to store the software or other machine-readable instructions and data. The memory may include volatile and/or non-volatile memory. Each computing device may also include a communication system to communicate via a wireline and/or wireless communications, such as through the Internet, an intranet, and Ethernet network, a wireline network, a wireless network, and/or another communication network. Each computing device may further include a display for viewing data, such as a computer monitor, and an input device, such as a keyboard or a pointing device (e.g., a mouse, trackball, pen, touch pad, or other device) for entering data and navigating through data, including exams, images, documents, structured data, unstructured data, HTML pages, other web pages, and other data.

Each computing device is communicatively connected to the IWS 114 through a communication network 110, such as a wide area network or via the Internet. Furthermore, data may proceed over paths that involve wire and wireless networks, both private and public. Various levels of access to the computing environment 100 may be provided though a password and user ID.

The presenter computing device 102 is associated with a webcast presenter desiring to create and control a webcast providing interactive web content. A presenter represents a person or organization responsible for running an event, or webcast. For example, a chief executive officer for a large corporation may be the presenter of a webcast. As another example, the dean of a University may be the presenter of a webcast.

The presenter may access a website through a browser using the presenter computing device 102 to access the ISW 114 to create and control webcast presentations providing interactive web content. The presenter then uses the keyboard and/or mouse associated with the presenter computing device 102 to create and/or import webcast slides that allow webcast attendees the ability to access and interact with interactive web content displayed through the webcast. Interactive web content may include any type of interactive or dynamic content accessible through the Internet such as: multimedia presentations, video, audio, interactive slides, chat, text, live websites, desktop sharing modules, linkage to third party webcasts, and access to virtual event platforms. In one aspect, any type of interactive web content may be accessed. In another aspect, interactive content may be generated from any form of many conventional sources such as a digital camera, camcorder, audio recorder, CD, DVD, computer, etc. Once such interactive content has been generated, the data may be entered as presentation data into the IWS 114. In one aspect, the presenter computing device 102 may be used to enter to create webcast slides before a presentation goes live, create and control webcast slides during a live presentation in real-time, or a combination of both.

For example, the dean of the University may use the presenter computing device 102 to generate a webcast slide allowing access to a University admitted student virtual tour platform. Additionally, the dean may create a webcast slide during a live webcast that allows students to access the university registration class website, allowing the students to interact with the website and register for classes during the webcast. As another example, a chief executive officer may create webcast slides for a corporate webcast that allow attendees to access and edit external corporate documents. Alternatively, the chief executive office may create a webcast slide that allows webcast attendees to access private and proprietary corporate systems.

The attendee computing devices 104, 106, 108 and 112 are associated with a webcast attendee or viewer, who intends to interact with the webcast presented by a presenter. For example, an attendee may access a webcast presented by a presenter by accessing a website associated with the webcast through a web browser at an attendee computing device. In one aspect, the attendee may provide account information such as a user name and login in order to access the webcast through the web browser. Once the webcast has been validly accessed, an attendee may, for example, use the keyboard and/or mouse associated with an attendee computing device 104, 106, 108, or 112 to interact with any of the interactive content displayed through the webcast offered by a presenter. While only four attendee computing devices are shown in computing environment 100 depicted in FIG. 1, it should be appreciated that the number of viewers could be tens, hundreds, thousands, or more. In one aspect, any person with access to the Internet may be a potential viewer of the interactive webcast presentation.

Referring again to the University example, an attendee of the University webcast may use the attendee computing device to access the university class registration page and register for classes. Referring to the corporate example, an attendee of the corporate webcast presented by the chief executive officer, may apply for promotions by interacting with the corporate website accessible through a webcast slide using an attendee computing device 104, 106, 108, and 112.

The IWS 114 includes an interactive webcast application 116 to generate one or more webcast slides comprising interactive webcast content. For example, the IWS 114 may generate a webcast slide allowing attendees to access external websites through the webcast slide during a live webcast. As another example, the IWS 114 may generate a webcast slide allowing attendees to access and interact with a 3^{rd} party virtual event platform and functionality. According to another aspect, the interactive web application 116 allows presenters to control a webcast attendee's ability to view, access, and interact with the interactive web content of a webcast slide during a live presentation. According to yet another aspect, the interactive web application 116 allows presenters to push and pull attendees into webcast slides known as breakout sessions. For example, a presenter may recreate a classroom setting by offering webcast attendees a way to breakaway from the main presentation and interact in small groups. Although the IWS is described in connection with generating webcast slides that provide access to interactive web content, it is contemplated that the methods and systems described herein may be applied to generate webcast slides providing access to static web content.

For example, the during the university webcast, the dean (presenter) may push webcast attendees such as students into breakout sessions relating to a students academic studies. Thus, an engineering webcast attendee may be pushed to a breakout session webcast slide offering access to interactive web content relating to engineering studies.

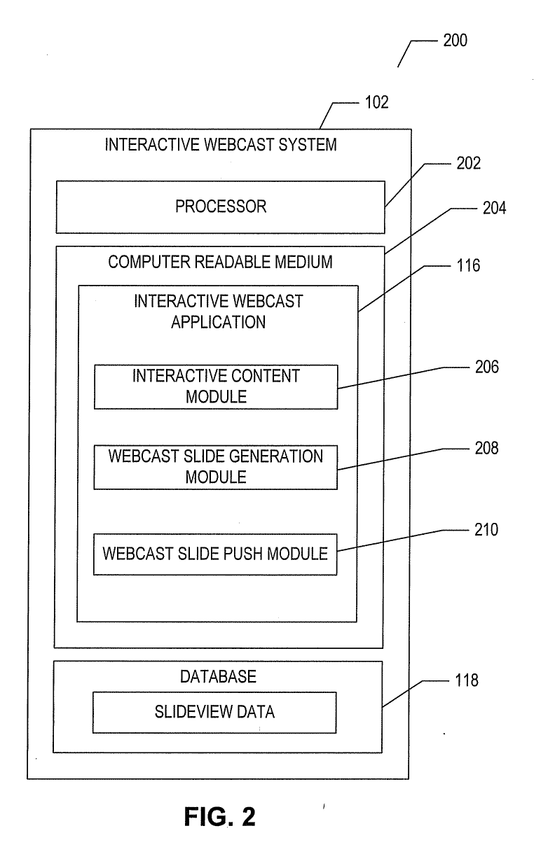

FIG. 2 is a block diagram that depicts an example IWS 114. According to one aspect, the IWS 114 includes a processor 202 that executes an interactive webcast application 116 to generate an interactive webcast. The processor 202 may include memory as well as other computing components and may reside on a computer, or other processing system. The IWS 114 may also include a computer readable media (“CRM”) 204 configured with the interactive webcast application 116. The IWS 114 may include a database 118 to store webcast slide data. According to one aspect, database 118 is a general repository of data including but not limited to interactive content, web content, webcast slides, webcast slide data, and any other type of interactive webcast presentation data. The database 118 may include memory and one or more processors or processing systems to receive, process, query and transmit communications and store and retrieve data. In another aspect, the database 118 may be a database server.

The interactive webcast application 116 includes instructions or modules that are executable by the processor 202. For example, in one embodiment, the interactive webcast application 116 includes a interactive content module 206, a webcast slide generation module 208, and a webcast slide push module 210. Other modules may also be included.

The interactive content module 206 obtains references to interactive content to be presented in an interactive webcast. A reference refers to an access point, pointer, link, portal, etc that offers or otherwise provides and links or accesses interactive web content. For example, the interactive content module 206 may obtain uniform resource locators (URLs) that provide access to specific interactive content such as multimedia presentations, video, audio, interactive slides, chat, text, live websites, desktop sharing modules, access to third party webcasts, and access to internal and/or external virtual event platforms. For example, the webcast may be a component of a virtual event platform and a reference to other areas of the virtual event platform may be obtained. A URL is an address that can be used to access objects, data, websites, etc on the web, or through other information systems.

For example, if the webcast were a corporate presentation to potential and existing employees, references to interactive content could be obtained such as URLs and links to external and existing corporate websites, corporate online games, presentations, etc. In another example, a digital video camera could be used to record the live video presentation of the chief executive officer (a type of presenter). Subsequently, the video could be stored on a server, and a reference to the video could be obtained by the interactive content module. A presenter, such as the chief executive officer may then create webcast slides including the reference to the interactive content within a frame, and push the webcast slides to attendees during a webcast. Attendees may access and interact with the web content accessible through the reference.

The webcast slide generation module 208 generates a webcast slide that incorporates the interactive content received by the dynamic content module 208 and stores the webcast slide in the database 118. In one aspect, the webcast slide is a self-contained webpage URL, rendered inside its own frame that allows for linkage to any external web content, such as interactive web content. For example, each webcast slide may be rendered in an HTML iframe. An HTML iframe is an inline frame embedded into a webpage or container page that contains content which is external to the webpage in which the iframe is currently embedded. Essentially, iframe functionality allows for access to external web content from a main webpage or container page. Thus, the iframe can link to any external web-based content accessible through the Internet or other network. When a webcast slide URL is rendered inside an iframe or slide area frame in the webcast, the webcast slide allows for access to any content retrievable through the specified URL, including interactive content. Once the webcast slides have been created an attendee of the webcast, using an attendee computing device, may interact with the content accessible through the webcast slide. Although the above examples have been described using HTML iframes, any suitable markup language or programming language capable of creating iframes, or iframe type functionality may be used.

In another aspect, the webcast slide generation module 208 may generate multiple webcast slides implemented as a list of URLs, and store the list in the database 118. The webcast slides are implemented as a list of URLs to be pushed to a webcast container page or slide area frame. In one aspect, the push mechanism is implemented using a message passing system. A message is sent from a presenter computing device, to a webcast system or application, such as IWS 114. The IWS subsequently communicates the message received from the presenter computing device to all of the webcast attendees, instructing the attendee's computing device to navigate an iframe represented within the webcast system to the specified slide. Thus, when a presenter pushes a webcast slide, a message is sent to attendees at attendee computing devices 104, 106, 108 and 112 instructing a host container page on which the webcast slide is displayed to navigate the webcast slide to the specified URL represented in the webcast slide. For example, a webcast slide S is created as a self-contained webpage URL linking to a corporate multimedia website. A presenter pushes the webcast slide S to the webcast host container page frame, which navigates to the specified URL. Any attendee viewing the webcast may now interact with the corporate multimedia website through the webcast slide. In another aspect, the webcast slide may be identified by a key value in the message. Accordingly, a webcast slide may be retrieved from the database 118 based on the key value, pushed to attendee computing devices and rendered in the appropriate iframe.

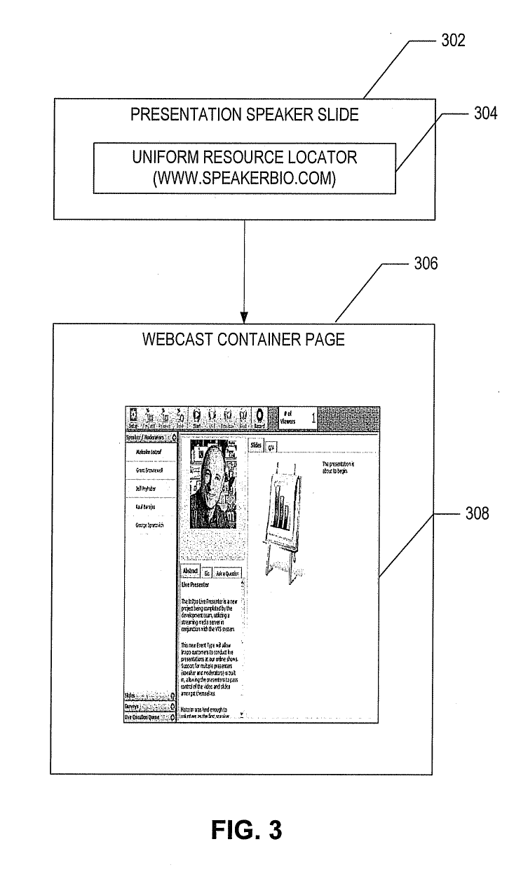

FIG. 3 is an example illustration of a webcast slide being rendered inside its own frame. An example URL linking to a speakers biography webpage received by the webcast generation module 208 is depicted at 304. The webcast slide generation module generates a webcast slide 302 incorporating the URL 304. During the live webcast, the webcast slide 302 renders the URL 304 inside its own frame 306, embedded inside a host or container webcast page, allowing attendees to interact with the interactive web content 308 accessible through the URL 304.

Referring back to FIG. 2, the webcast slide push module 210 allows a presenter to manage and control webcast slides that are presented to attendees. For example, a presenter may push different webcast slides to attendees throughout a live webcast as described above. As a presenter pushes different webcast slides to the attendees, attendees may view and hear the presenter through streaming video and audio feeds of the webcast, allowing the presenter to provide comments and directions about how attendees should interact with interactive content being displayed in real-time.

In another aspect, the webcast slide push module 210 allows a presenter to create a classroom setting by offering attendees the ability to break away from the main webcast presentation into a breakout session, consisting of two or more attendees. A breakout session is a particular type of webcast slide that allows an attendee to interact with a limited number of attendees separate from the main presentation. In one aspect, a breakout session may be accessed through a webcast slide like any other interactive content. For example, attendees may access a breakout session by clicking a specific URL in webcast slide. Once an attendee accesses the URL, the attendee is advanced to a interactive content representing a breakout session. For example, the breakout session may be a show feature or a booth (a show feature or booth is a space within a virtual event platform or environment of which a webcast is a component), or a live chat or video-conferencing room. In another aspect, the presenter may populate the breakout room with content, such as video, audio, or any other type of interactive content. Attendees may be assigned to a breakout session by a presenter, or an attendee may choose to enter a breakout session. Alternatively, attendees may be pulled back to the main presentation by presenters, or an attendee may choose to leave a breakout session. Once an attendee has accessed a breakout session, the attendee may interact with other attendees in the same breakout session through audio, video, chat, etc.

In another aspect the webcast slide push module 210 allows a presenter to control how attendees may interact with the content accessible through a webcast slide. For example, if a webcast slide presents an external interactive website, the presenter may deactivate any access to the interactive components of the interactive website, such as games, videos, links, etc. At a later time, the presenter may reactivate the interactive components. In one aspect, the presenter may click an enablement checkbox option that has been defined in the webcast slide. Subsequently, a transparent layer that intercepts all click actions and keystrokes is created and placed over the interactive content accessible through the webcast slide, thereby rendering the live content as view-only. In one aspect, the transparent layer implemented using a HTML DIV element, which may be used to define a division or a section in an HTML document and/or format them with styles.

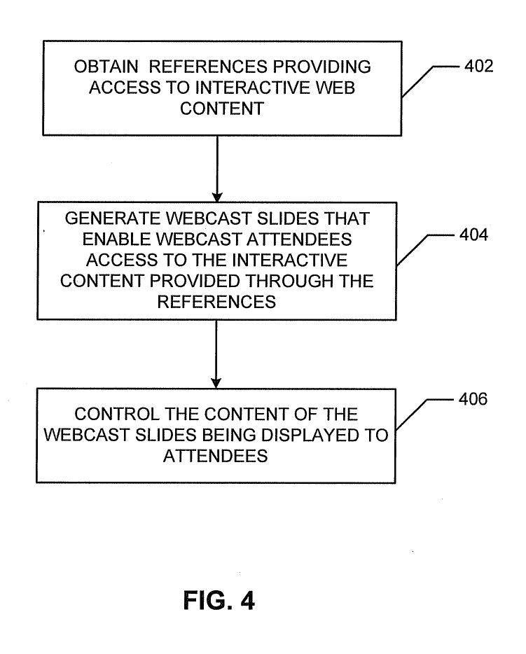

FIG. 4 depicts an example method for providing a webcast with interactive content. At 402, references providing access to interactive web content is obtained at the IWS 114. For example, a presenter provides a list of URLs to the IWS 114. At 404, webcast slides are generated that enable webcast attendees to access to the interactive content provided through the references. Once the webcast slides have been generated and pushed to attendees, the contents of each webcast slide is controlled by a presenter at 406. For example, the presenter may elect to deactivate all or part of the interactive components of the interactive web content exposed through the webcast slide in the frame.

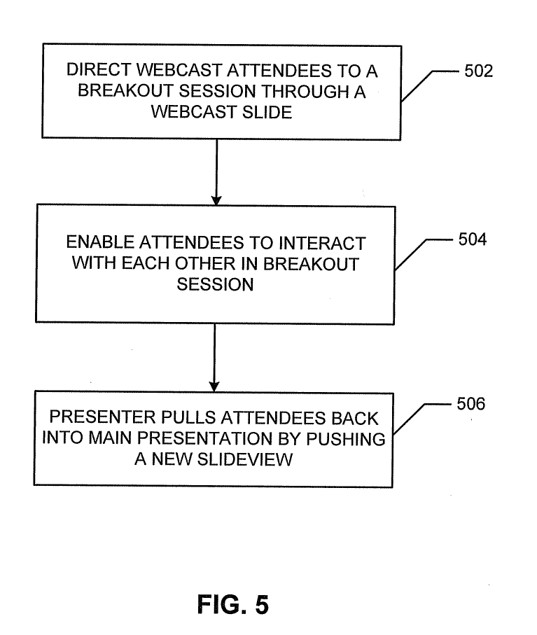

FIG. 5 depicts an example method for managing a breakout session during an interactive webcast. At 502, attendees are pushed to a breakout session through a webcast slide by a presenter. For example, webcast attendees may be pushed to a webcast slide linking to a third party virtual platform booth. At 504, the presenter allows the attendees in the breakout session to interact. For example, attendees may interact through chat functions. Once the breakout sessions have been completed, the presenter may push attendees back into the main presentation by pushing another webcast slide at 506.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A method for providing interactive content in a webcast comprising:
obtaining, at one or more processors, one or more references providing access to interactive web content;
generating, at the one or more processors, one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame; and
providing for pushing the one or more webcast slides to the self-contained frame in a host container page of a webcast.

2. The method of claim 1, wherein the interactive web content comprises at least one of video, audio, web applications, external webcasts, live websites, and desktop sharing modules.

3. The method of claim 1, further comprising deactivating portions of the interactive web content the attendee may interact with by creating a transparent layer over the interactive web content accessible through the webcast slide that intercepts all click actions and keystrokes by the attendee.

4. The method of claim 1, wherein obtaining the one or more references is in real-time during a webcast.

5. The method of claim 1, wherein the providing for pushing includes sending a message comprising a key value identifying a particular webcast slide, the message instructing the self-contained frame to render the particular webcast slide identified by the key value.

6. The method of claim 1, further comprising pushing, during a live webcast, a breakout session webcast slide to at least one other attendee, wherein the at least one attendee and the at least one other attendee are viewing different interactive web content.

7. The method of claim 1, wherein the self-contained frame is an HTML iframe.

8. A system for providing interactive content in a webcast comprising:
a processor;
an interactive webcast application comprising modules executable by the a processor, the modules comprising:
an interactive content module to obtain one or more references, the one or more references providing access to interactive web content;
an webcast slide generation module to generate one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame; and
an webcast slide push module to provide for pushing the one or more webcast slides to the self-contained frame in a host container page of a webcast.

9. The system of claim 8, wherein the interactive web content comprises at least one of video, audio, web applications, external webcasts, live websites, and desktop sharing modules.

10. The system of claim 8, the webcast slide push module further configured to send a message comprising a key value identifying a particular webcast slide, the message instructing the self-contained frame to render the particular webcast slide identified by the key value.

11. The system of claim 8, wherein obtaining the one or more references is in real-time during a webcast.

12. The system of claim 8, the webcast slide push module further configured to push, during a live webcast, a breakout session webcast slide to at least one other attendee, wherein the at least one attendee and the at least one other attendee are viewing different interactive web content.

13. The system of claim 8, wherein the self-contained frame is an HTML iframe.

14. The system of claim 8, the webcast slide push module further configured to deactivate portions of the interactive web content the attendee may interact with by creating a transparent layer over the interactive web content accessible through the webcast slide that intercepts all click actions and keystrokes by the attendee.

15. A computer-readable medium encoded with an interactive webcast application for providing interactive content in a webcast comprising modules executable by a processor comprising:
an interactive content module to obtain one or more references, the one or more references providing access to interactive web content;
an webcast slide generation module to generate one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame; and
an webcast slide push module to provide for pushing the one or more webcast slides to the self-contained frame in a host container page of a webcast.

16. The computer-readable medium of claim 15, wherein the interactive web content comprises at least one of video, audio, web applications, external webcasts, live websites, and desktop sharing modules.

17. The computer-readable medium of claim 15, the webcast slide push module further configured to send a message comprising a key value identifying a particular webcast slide, the message instructing the self-contained frame to render the particular webcast slide identified by the key value.

18. The computer-readable medium of claim 15, wherein the one or more references providing access to interactive web content are obtained in real-time during a webcast.

19. The computer-readable medium of claim 15, wherein the self-contained frame is an HTML iframe.

20. The computer-readable medium of claim 15, the webcast slide push module further configured to push, during a live webcast, a breakout session webcast slide to at least one other attendee, wherein the at least one attendee and the at least one other attendee are viewing different interactive web content.

21. The computer-readable medium of claim 15, the webcast slide push module further configured to deactivate portions of the interactive web content the attendee may interact with by creating a transparent layer over the interactive web content accessible through the webcast slide that intercepts all click actions and keystrokes by the attendee.
